(19) United States
(12) Patent Application Publication
(10) Pub. No.: US 2006/0041473 A1
(43) Pub. Date: Feb. 23, 2006

(54) Date-triggered CD-ROM telephone directory

(76) Inventors: A. Douglas Harrell, Bakersville, NC (US); Ronald G. Mintle, Fallbrook, CA (US)

Correspondence Address: STEVEN C. SCHNEDLER;CARTER SCHNEDLER & MONTEITH, PA, 56 CENTRAL AVE., SUITE 101, PO BOX 2985, ASHEVILLE, NC, 28802, US

(21) Appl. No.: 11/166,693

(22) Filed: Jun. 23, 2005

Related U.S. Application Data
(60) Provisional application No. 60/603,370, filed on Aug. 20, 2004.

(51) Int. Cl. G06Q 30/00

(52) U.S. Cl. 705/14

(57) ABSTRACT

An electronic directory for advertising products and services for use in combination with a computer system including a display and including a clock/calendar which maintains current date and time information, and a method of providing such a directory. The electronic directory includes a computer-readable medium having computer readable-program code and data comprising a database embodied thereon. The database in turn comprises data representing a business telephone directory including advertising content in the form of a plurality of individual advertising elements. At least some of the individual advertising elements are encoded with date information indicating on which date or dates particular individual advertising elements are to be active The computer-readable program code is operable to cause display of particular ones of the at least some of the individual advertising elements only when the encoded date information matches the current date as maintained by the computer system clock/calendar.

### CROSS-REFERENCE TO RELATED APPLICATION

The benefit of U.S. provisional patent application Ser. No. 60/603,370, filed Aug. 20, 2004, is claimed.

### BACKGROUND OF THE INVENTION

The invention relates generally to searchable directories including advertising content, such as telephone “yellow pages” directories, provided on computer-readable media, such as a CD-ROM.

### SUMMARY OF THE INVENTION

In one aspect an electronic directory for advertising products and services is provided, for use in combination with a computer system including a display and including a clock/calendar which maintains current date and time information. The electronic directory includes a computer-readable medium having computer-readable program code and data comprising a database embodied thereon. The database in turn comprises data representing a business telephone directory including advertising content in the form of a plurality of individual advertising elements. At least some of the individual advertising elements are encoded with date information indicating on which date or dates each of the at least some of said individual advertising elements is to be active. The computer-readable program code is operable to cause display of particular ones of the at least some of the individual advertising elements only when the encoded date information matches the current date as maintained by the computer system clock/calendar.

In another aspect, a method of providing a directory for advertising products and services is provided. The method includes providing a computer-readable medium having computer-readable program code and data comprising a database embodied thereon, the computer-readable medium being for use in combination with a computer system including a display and including a clock/calendar which maintains current date and time information. The database in turn comprises data representing a business telephone directory including advertising content in the form of a plurality of individual advertising elements. At least some of the individual advertising elements are encoded with date information indicating on which date or dates each of the at least some of said individual advertising elements is to be active. The computer-readable program code is operable to cause display of particular ones of the at least some of the individual advertising elements only when the encoded date information matches the current date as maintained by the computer system clock/calendar.

### BRIEF DESCRIPTION OF THE DRAWINGS

FIG. 1 is a representation of a computer system and an electronic directory comprising a computer-readable medium, in particular a CD-ROM, embodying the invention;

FIG. 2 is a block diagram representation of computer-readable program code and data representing a database embodied or recorded on the CD-ROM of FIG. 1;

FIG. 3 is a representation of a page from a business telephone directory formatted as a page of the “yellow pages” of a conventional telephone directory, including a display ad, as presented or rendered on the video monitor of the FIG. 1 computer system;

FIG. 4 is a representation of the same page as is represented in FIG. 3, differing in that the display ad has changed to reflect a different season;

FIG. 5 is a representation of another page from a business telephone directory formatted as a page of the “yellow pages” of a conventional telephone directory, including a display ad which has mouse-clickable “buttons” which link to audio and audio/video recordings to provide further advertising content; and

FIG. 6 is a representation of yet another page from a business telephone directory formatted as a page of the “yellow pages,” including several restaurant display ads including mouse-clickable “menu” buttons.

### DETAILED DESCRIPTION

In overview, an electronic directory for advertising products and services is provided, embodied or provided on computer readable media, such as a CD-ROM, and may generally be characterized as a “CD-ROM telephone directory.” The provider of a “CD-ROM telephone directory generally distributes CD-ROMs to consumers free of charge, and derives revenue from advertisers. In many cases it is desirable for advertisements and coupons to change from time to time. For example, many products and services are seasonal, and advertisers may wish to offer promotional coupons only at particular times. Such concerns can readily be accommodated by an internet directory, but internet directories require on-line access, can be slow depending on the connection speed, and are not always available. Previous “CD-ROM telephone directories” have addressed such concerns with frequent “update” CD-ROMs, such as monthly, a potentially costly approach. Embodiments of the invention take a different approach, and have date information encoded with the advertising content. Particular individual advertising elements are active, i.e. subject to display, only when the encoded date information matches the current date as maintained by a clock/calendar unit included in a computer system with which the CD-ROM is used. Accordingly, date-sensitive advertising content is provided without having to provide an “update” CD-ROM and without access to the internet being required.

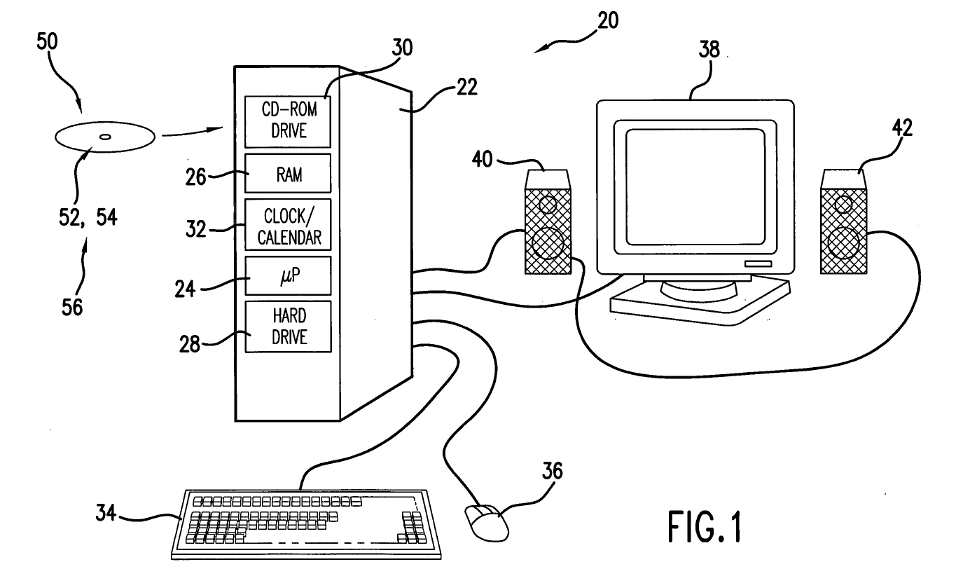

Referring now in detail to FIG. 1, a computer system 20 includes a conventional enclosure 22, incorporating a number of conventional elements, in particular a microprocessor 24, memory (RAM) 26, a mass storage device such as a hard disk drive 28, a removable media drive 30 such as a CD-ROM drive 30, and a system clock/calendar unit 32 which maintains current date and time information. The CD-ROM drive 30 is representative of any hardware device which is capable of reading information from computer-readable media including, but not limited to, digital versatile disk (DVD) readers, large-capacity magnetic media readers, memory card readers, and a removable universal serial bus (USB) interfaced device. The computer system 20 additionally includes a keyboard 34 and mouse 36 as input devices, as well as a video display monitor 38 and speakers 40 and 42 as output devices.

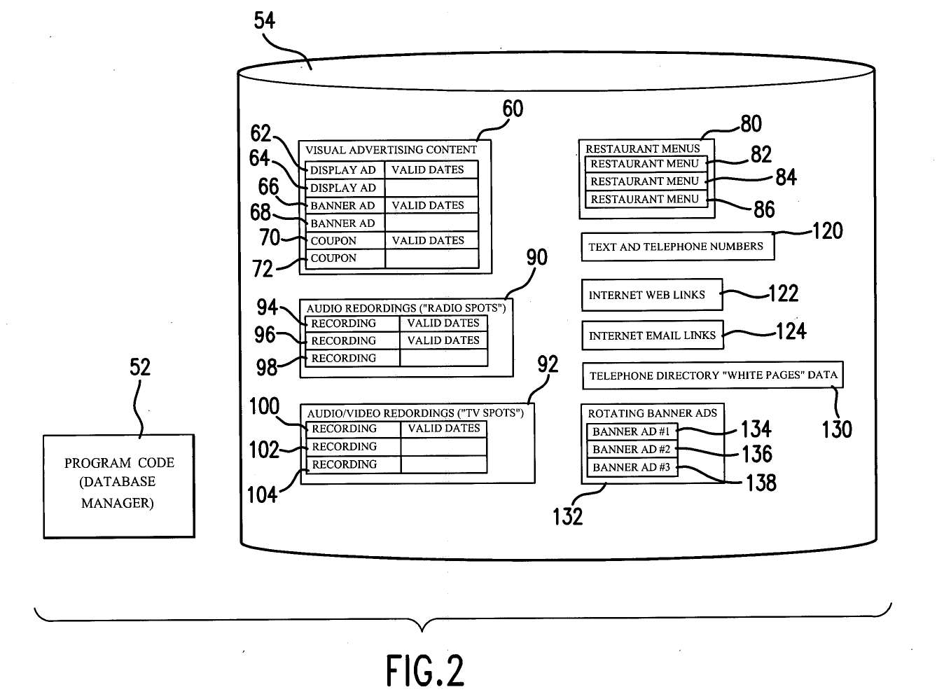

A computer-readable medium 50 has computer-readable program code 52 and data comprising a database 54 embodied or recorded thereon, for use in combination with the computer system 20. The program code 52 and data comprising a database 54 are described in greater detail hereinbelow, particularly with reference to FIG. 2. In the illustrated embodiment, the computer-readable medium comprises a CD-ROM 50 which is inserted into the CD-ROM drive 30. This particular form of computer-readable medium 50 is representative only. Other examples of a computer-readable medium 50, which examples are provided by way of example and without limitation, are a digital versatile disk (DVD), a high-capacity magnetic medium, a removable hard disk drive, a removable memory card, and a removable USB-interfaced device.

In any event, the computer-readable medium 50, represented as a CD-ROM 50, is inserted into an appropriate slot in the enclosure 22 or appropriately connected. The microprocessor 24 within the enclosure 22, as directed by the operating system, reads and executes the program code 52 embodied or stored on the computer-readable medium 50, reads and searches the database 54, and presents data in both visual and audible form via the video monitor 38 and the speakers 40 and 42, as described hereinbelow. Accordingly, the computer-readable medium 50, including the program code 52 and data representing a database 54 embodied or recorded thereon, may be referred to as an electronic directory 56.

The program code 52 and the data comprising a database 54 embodied or recorded on the computer-readable medium 50 may be run directly from the computer-readable medium (e.g., CD-ROM). Alternatively, the information recorded on the computer-readable medium 50 (e.g., CD-ROM) may optionally be copied or “installed” onto the hard disk drive 28 within the enclosure 22, which typically provides faster data access. In either event, all references herein to the computer-readable program code 52 and data comprising a database 54 refer equally and alternatively to the program code 52 and data comprising a database 54 whether accessed directly from the original computer-readable medium 50 (e.g., CD-ROM), or accessed from a version copied and installed to the hard disk drive 28, or a combination thereof. What is significant is that the data, including date-sensitive or date-triggered advertising content as described hereinbelow, is local to the computer system 20, and the operation of date-triggered or date-sensitive aspect is not dependent upon access to the internet.

In general, the database 54 comprises a business (i.e., “yellow pages”) telephone directory, including advertisements. A user is able to search the database 54 or scroll through the database 54 to find businesses offering products and services of interest. The database 54 may be searched or organized under specific headings. Advertising content is in the form of a plurality of individual advertising elements, examples of which include display ads, banners, coupons, audio recordings (referred to herein as “radio spots”), audio/video recordings (referred to herein as “TV spots”), and restaurant menus.

A significant aspect is the ability for individual advertising elements to be seasonal. Thus, date information is encoded with at least some of the individual advertising elements. Depending upon the particular date as maintained by the clock/calendar unit 32, individual advertising elements presented change or switch on specific dates.

FIG. 2 more particularly represents the program code 52 and database 54 embodied or recorded on the computer-readable medium 50. The program code 52 essentially is a database manager, including data retrieval and searching capabilities, as well as formatting and display capabilities. The program code 52 additionally includes instructions to access the system clock/calendar unit 32 for comparison with date information in the database 54 when encoded with individual advertising elements. The database 54 includes various data elements, described in detail next below, which represent a business telephone directory including advertising content in the form of a plurality of individual advertising elements. It will be appreciated that the program code 52 when executed by the microprocessor 24 within the enclosure 22 reads and organizes data from the database 54, and presents a rendering or display in a human-readable form on the video monitor 38 and, in some cases, plays audio content through the speakers 40 and 42.

Represented in FIG. 2 is data representing visual advertising content 60, in particular data for two display ads 62 and 64, two banner ads 66 and 68, and two coupons 70 and 72. Some of the individual advertising elements are also encoded with date information indicating on which date or dates the particular individual advertising element is to be active. In the particular example of FIG. 2, the display ad 62, the banner ad 66 and the coupon 70 are so encoded. The other display ad 64, the other banner ad 68 and the other coupon 72 are not encoded with date information (the date field is blank), and so remain unchanged whenever displayed. These visual advertising content elements are stored or embodied on the computer-readable medium 50 in any suitable format, but typically are stored as image files such as .gif or .jpg image files.

Another category of advertising element stored as data within the database 54 is restaurant menus 80 represented as individual restaurant menus 82, 84 and 86. Typically, restaurant menus are not encoded with date information, and accordingly no date field is indicated in FIG. 2. However, the restaurant menus 82, 84 and 86 certainly can be encoded with date information, in the same manner as described above with reference to the visual advertising content 60.

Advertising elements additionally include audio recordings, generally designated 90, and which may be referred to as “radio spots,” and audio/video recordings, generally designated 92, which may be referred to as “TV spots.” Representative individual audio recordings (“radio spots”) include audio recordings 94, 96 and 98. In the particular example of FIG. 2, the audio recordings 94 and 96 are encoded with valid date information. However, the date field for the representative audio recording 98 is blank. Representative audio/video recordings (“TV spots”) include audio/video recordings 100, 102 and 104. Audio/video recording 100 is encoded with valid date information in the particular example of FIG. 2, while audio/video recordings 102 and 104 have the date field blank.

The audio recordings 90 (“radio spots”) and the audio/video recordings 92 (“TV spots”) are embodied or stored on the computer-readable medium 50 in any one of a variety of formats, in a conventional manner. As one example, audio recordings may be stored as .mp3 files.

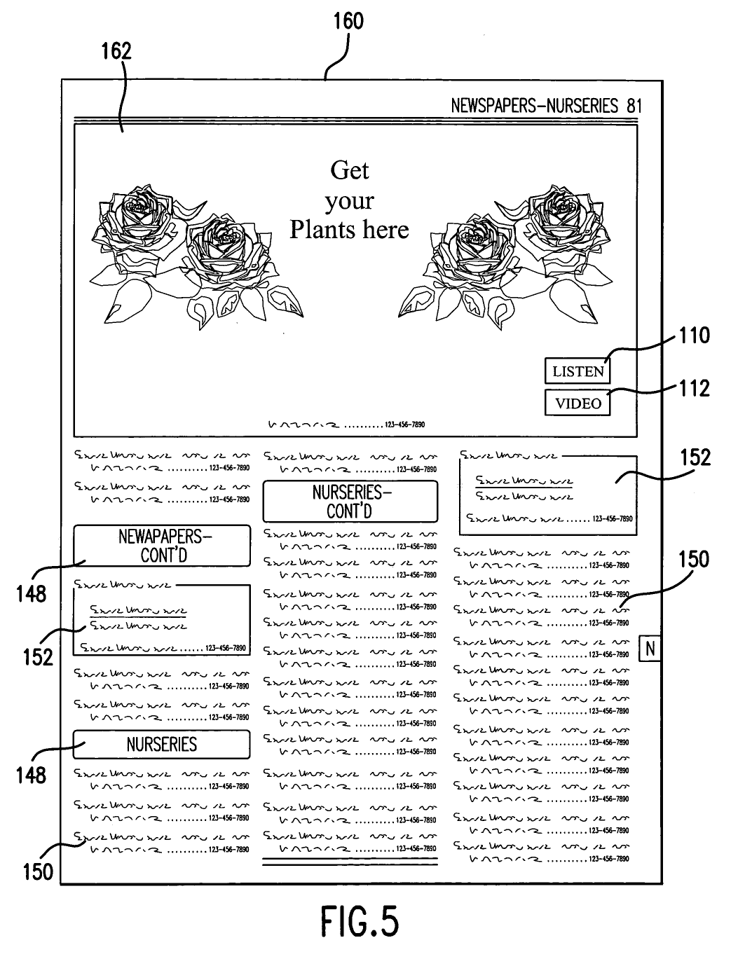

As described hereinbelow with reference to FIG. 5, typically the audio recordings 90 (“radio spots”) and the audio/video recordings 92 (“TV spots”) are invoked by mouse-clickable buttons, such as a “listen” button 110 and a “video” button 112 which, in a conventional manner, link to the audio and video files embodied on or stored on the computer-readable medium 50.

Still referring to FIG. 2, additional data which is included as part of the database 54 includes “yellow pages” text and telephone numbers 120 to be rendered as text-only listings in the telephone directory “yellow pages,” that is, without any display ad content.

Other data embodied within the database 54 includes internet web links 122 and internet e-mail links 124, which are typically embedded within other advertising content. At this point, it is relevant to note that the electronic directory is functional without the computer system 20 being connected to the internet. In other words, the advertising content, including encoded date information, is embodied or recorded on the computer-readable medium 50. The ability for a user of an internet-connected computer to “click” on internet web links and internet e-mail links is an additional capability. Advertisers who use this feature are of course able to provide internet web page content which changes at any time in a conventional manner.

The database 54 also includes conventional telephone directory “white pages” data, represented at 130.

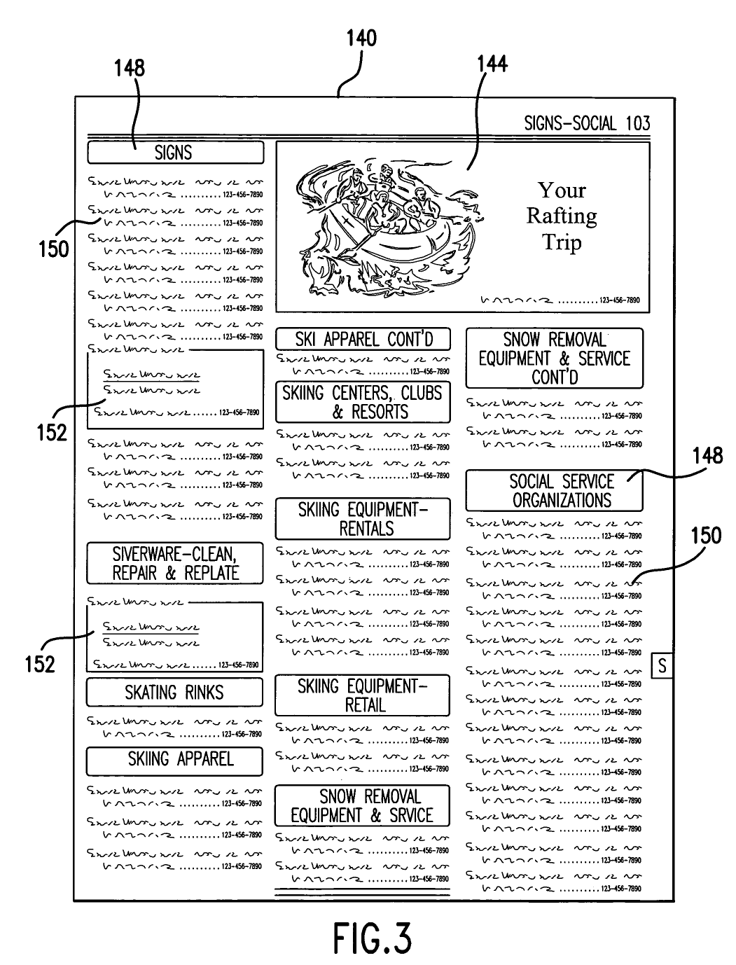

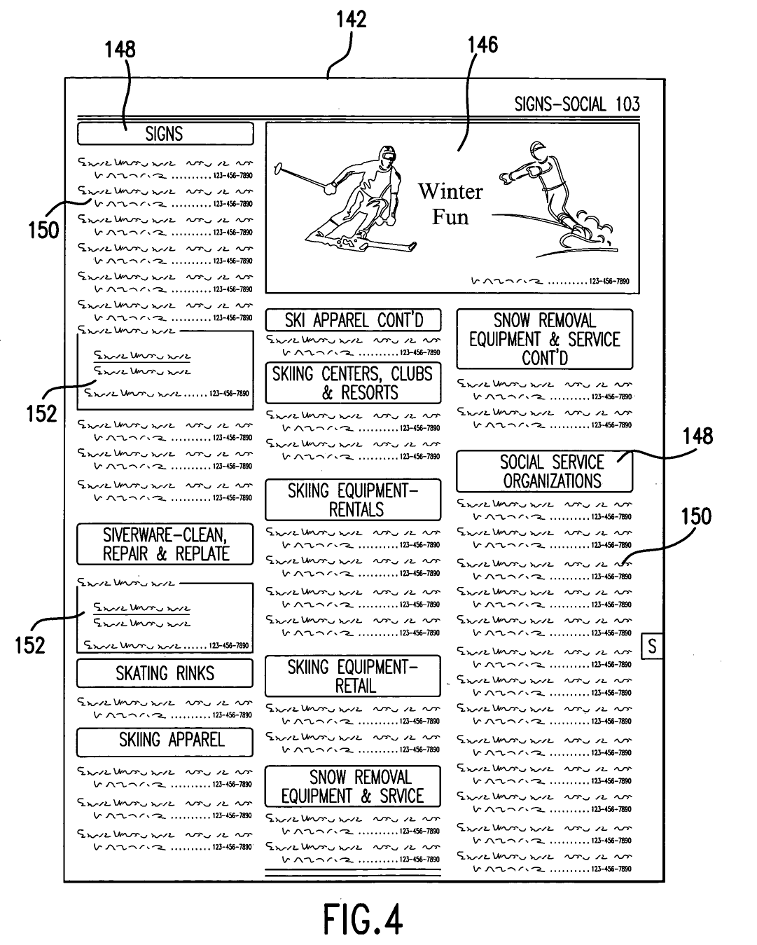

With reference now to FIGS. 3 and 4, depicted are two versions, on different dates, of a page in the format of a page from a business telephone directory, typically referred to as the “yellow pages,” displayed or rendered on the video monitor 38 by execution of the program code 52 based on data within the database 54, and under control of a user. The “yellow pages” page 140 of FIG. 3 and the “yellow pages” page 142 of FIG. 4 are identical, with the exception of a particular display ad, designated 144 in FIG. 3 and 146 in FIG. 4. The display ads 144 and 146 are identical in size, and occupy the same space on the page. They differ according to the season.

In FIG. 3, display ad 144 appears, based on the date encoded information, during warmer months of the year, and depicts white water rafting. The display ad 146, which is for the same business, and is for snow skiing, appears during the colder months of the year, for example, beginning in December.

Other elements of the FIGS. 3 and 4 “yellow pages” telephone directory pages include headings 148, plain text listings 150, and smaller in-column listings 152.

With reference to FIG. 5, depicted is another example of a page 160 from telephone directory “yellow pages” as rendered on the video monitor 38 based on data within the database 54, through execution of the program code 52. Included on the page 160 is a display ad 162, which in-turn incorporates the “listen” button 110 and the “video” button 112 which, when clicked employing the mouse 36, access either an audio recording or an audio/video recording within the database 54 in stored or embodied on the computer-readable medium 50. Although the particular display ad 162 includes both the “listen” button 110 and the “video” button 112, typically an individual ad would include one or the other, but not both, in cases where a particular advertiser has decided to employ this particular feature. The linked audio or audio/video data may likewise be date encoded such that the particular “radio spot” or “TV spot” which is presented varies by date, for example, by season.

Although not shown in the drawing, the display ad 162 of FIG. 5, which is for a plant nursery, is also date triggered, like the display ads 144 and 146 of FIGS. 3 and 4. During the spring and summer, nursery plants are advertised. Beginning December 1st, Christmas trees are advertised.

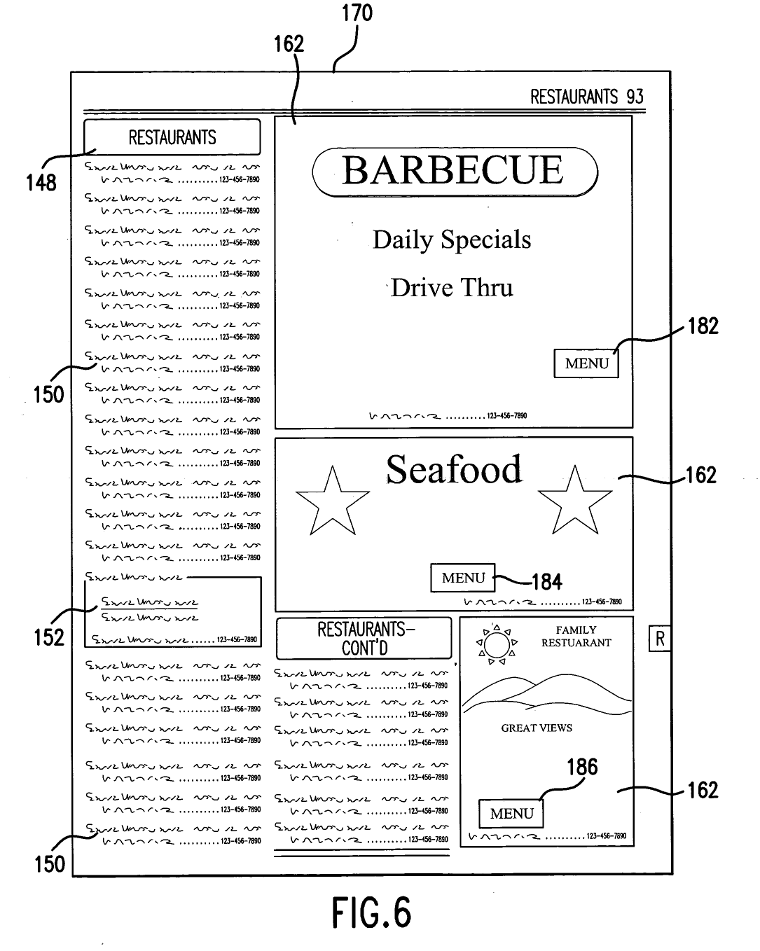

Finally, FIG. 6 depicts another “yellow pages” page 170 which includes several restaurant display ads 172, 174 and 176. Each of the restaurant display ads 172, 174 and 176 includes a “menu” button 182, 184 or 186 which, when “clicked” employing the mouse, causes a restaurant menu to be displayed. The menus are stored as image files, such as .jpg or .gif image files.

In the event the database program code 52 and database 54 have been copied or installed to the hard disk drive 28, the further capability may be provided to update information stored on the hard disk drive 28 via the internet. However, internet access is not required for embodiments of the invention to function.

While particular embodiments of the invention have been illustrated and described herein, it is realized that numerous modifications and changes will occur to those skilled in the art. It is therefore to be understood that the appended claims are intended to cover all such modifications and changes as fall within the true spirit and scope of the invention.

What is claimed is:

1. An electronic directory for advertising products and services for use in combination with a computer system including a display and including a clock/calendar which maintains current date and time information, said electronic directory comprising:
a computer-readable medium having computer-readable program code and data comprising a database embodied thereon;
said database in turn comprising data representing a business telephone directory including advertising content in the form of a plurality of individual advertising elements;
at least some of said individual advertising elements being encoded with date information indicating on which date or dates each of said at least some of said individual advertising elements is to be active; and
said computer-readable program code operable to cause display of particular ones of said at least some of said individual advertising elements only when the encoded date information matches the current date as maintained by the computer system clock/calendar.

2. The electronic directory of claim 1, wherein said computer-readable program code is operable to present the business telephone directory data in a format representing a conventional “yellow pages” telephone directory, including at least some advertising elements which change depending on the current date as maintained by the computer system clock/calendar.

3. The electronic directory of claim 1, wherein the individual advertising elements are selected from the list consisting of display ads, banners, coupons, audio recordings, audio/video recordings, and restaurant menus.

4. A method of providing a directory for advertising products and services, said method comprising:
providing a computer-readable medium having computer-readable program code and data comprising a database embodied thereon, the computer-readable medium being for use in combination with a computer system including a display and including a clock/calendar which maintains current date and time information;
the database in turn comprising data representing a business telephone directory including advertising content in the form of a plurality of individual advertising elements;
at least some of the individual advertising elements being encoded with date information indicating on which date or dates each of said at least some of the individual advertising elements is to be active; and
the computer-readable program code operable to cause display of particular ones of said at least some of said individual advertising elements only when the encoded date information matches the current date as maintained by the computer system clock/calendar.

5. The method of claim 4, wherein the computer-readable program code is operable to present the business telephone directory data in a format representing a conventional “yellow pages” telephone directory, including at least some advertising elements which change depending on the current date as maintained by the computer system clock/calendar.

6. The method of claim 4, wherein the individual advertising elements are selected from the list consisting of display ads, banners, coupons, audio recordings, audio/video recordings, and restaurant menus.
